(19) United States
(12) Patent Application Publication
(10) Pub. No.: US 2013/0038076 A1
(43) Pub. Date: Feb. 14, 2013

(54) VEHICLE BUMPER

(71) Applicants: Guido Benvenuto, LaSalle (CA); Paul Dazey, Belleville, MI (US); Aaron Boyer, Washington, MI (US); Steven Perucca, Clinton Township, MI (US)

(72) Inventors: Guido Benvenuto, LaSalle (CA); Paul Dazey, Belleville, MI (US); Aaron Boyer, Washington, MI (US); Steven Perucca, Clinton Township, MI (US)

(73) Assignee: FLEX-N-GATE ADVANCED PRODUCT DEVELOPMENT LLC, Warren, MI (US)

(21) Appl. No.: 13/572,355

(22) Filed: Aug. 10, 2012

Related U.S. Application Data
(60) Provisional application No. 61/522,616, filed on Aug. 11, 2011.

(51) Int. Cl. B60R 19/03

(52) U.S. Cl. 293/120

(57) ABSTRACT

A vehicle bumper assembly includes a polymeric support structure and a metal cover. The polymeric support structure may be one piece or a multi-piece component. The polymeric support structure includes a plurality of ribs formed on a substantially vertical wall. The chrome-plated metal cover is disposed on the one-piece polymeric support structure.

### CROSS-REFERENCE TO RELATED APPLICATIONS

This patent application claims priority to U.S. Provisional Patent Application bearing the Ser. No. 61/522,616 filed on Aug. 11, 2011. The contents of which are hereby incorporated by reference.

### BACKGROUND

The present disclosure relates to a bumper for use on a vehicle, such as but not limited to a pick-up truck.

Energy management characteristics of a vehicle bumper are a primary consideration in order to reduce injury and/or damage in a vehicle collision. Bumpers are frequently made to be heavy-duty to provide sufficient strength in order to pass impact and functional bumper testing.

In traditional chrome plated truck bumpers, a bumper beam in the form of a chrome member is generally attached to the vehicle frame through a series of brackets using mechanical fasteners, a welding process or the like. The thickness of the chrome member is generally in the thickness range of 1.4-1.8 mm.

However, such heavy duty, chrome-plated bumpers on vehicles such as trucks results in increased cost and increased weight which can also negatively affect fuel efficiency. Accordingly, it is desired to provide a bumper with improved crush strength, improved step load capability, and improved energy absorption while simultaneously decreasing weight, design complexity in addition to decreasing assembly costs/time.

Accordingly, a bumper system having the aforementioned advantages and solving the aforementioned problems is desired.

### SUMMARY

A vehicle bumper assembly is provided according to the embodiments disclosed herein. The vehicle bumper assembly includes a polymeric support structure and a metal cover. The polymeric support structure includes a plurality of ribs which may be formed on a substantially vertical wall. The chrome-plated metal cover is disposed on the polymeric support structure.

### BRIEF DESCRIPTION OF THE DRAWINGS

The present invention will now be described by way of example, with reference to the accompanying drawings:

FIG. 1 illustrates a front view of a bumper assembly of the present disclosure wherein the interior surface of the support structure is shown.

FIG. 2 illustrates an isometric view of an interior surface of an embodiment of the support structure.

FIG. 3 illustrates a cross-sectional view is shown along lines A-A in FIG. 2.

FIG. 4 illustrates a partial rear isometric view of a non-limiting example of the support structure of the present disclosure

FIG. 5 illustrates a rear isometric view wherein the chrome plated metal cover 24 is disposed on the support structure 12

### DETAILED DESCRIPTION

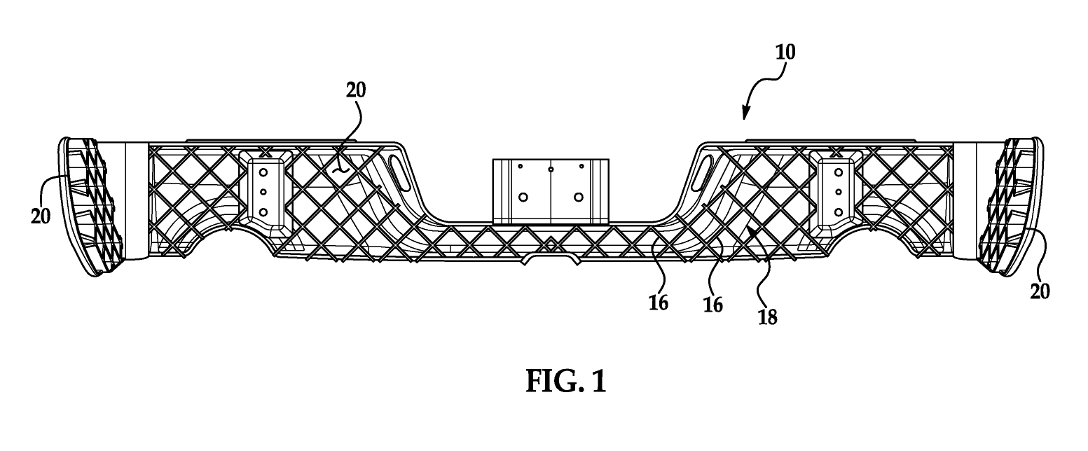

Referring now to FIG. 1 of the present disclosure, a front view of an embodiment of the bumper assembly 10 of the present disclosure is shown. The interior surface 18 of the bumper assembly 10 is illustrated. The interior surface 18 shown abuts against the vehicle structure 34 and may be attached to the vehicle structure 34 via the frame (not shown) and/or outer sheet metal 36.

As shown in FIG. 1, the bumper assembly 10 may include an injection molded support structure 12 which may be a single piece component or a multi-piece component. Where the support structure 12 is a multi-piece structure, the support structure 12 may be assembled using mechanical fasteners, adhesives or the like.

The support structure 12 may include a honeycomb-like structure 14 and/or a ribbed structure as illustrated. With reference to FIG. 1, the ribs 16 may be integral to the substantially vertical walls 20 (shown in FIGS. 1 and 3) of the support structure 12. The non-limiting example of FIG. 1 shows the plurality of ribs 16 disposed in opposing, diagonal directions thereby creating a honeycomb-like structure 14. The integral ribs 16, the honeycomb-like structure 14 and the integral substantially vertical walls 20 provide a significantly stronger structure while having a reduced weight.

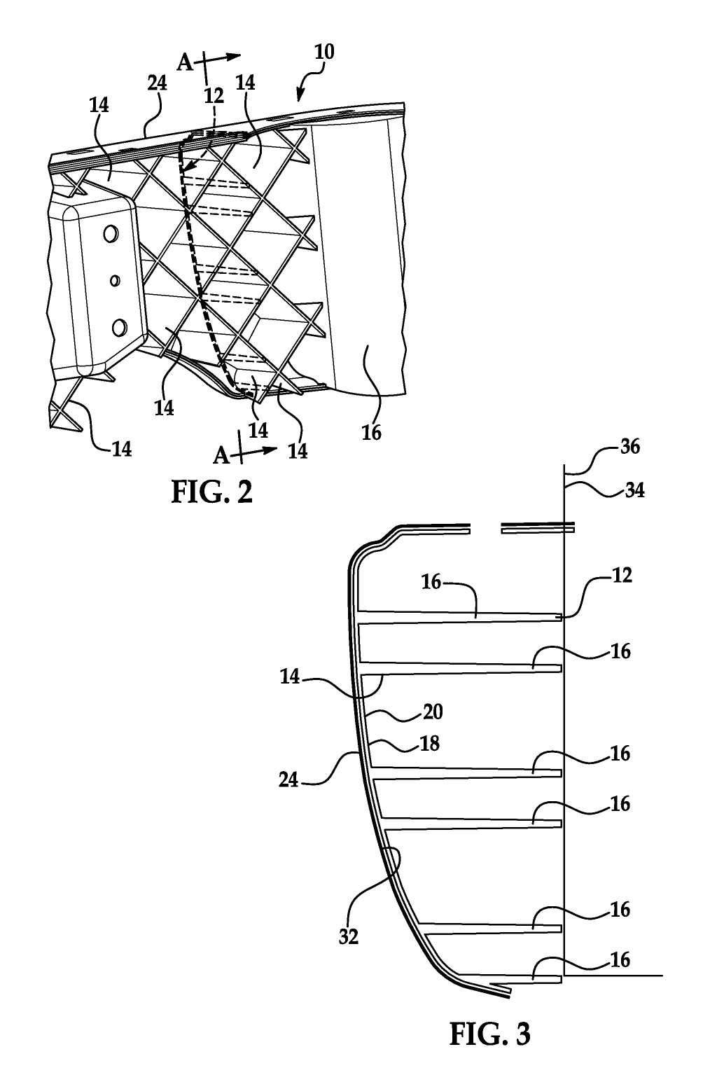

With reference to FIG. 2, an isometric view of an interior surface 18 of an embodiment of the support structure 12 is shown. The ribs 16 again are shown in the non-limiting example as being disposed in opposing diagonal directions. It is to be understood that the ribs may be disposed in any particular direction such as, but not limited to horizontally, vertically as well as diagonally. The intersection of the ribs 16 creates a plurality of recesses or cavities thereby improving stiffness and strength in the support structure 12 while reducing the weight of the bumper assembly 10.

Referring now to FIG. 3, a cross-sectional view is shown along lines A-A in FIG. 2. As shown, the ribs 16 are integral to the substantially vertical walls 20. Furthermore, in the non-limiting example of FIG. 3, the ribs 16 may have varying lengths so as to terminate at the same point along the x-axis 22. The benefit of having such a configuration may be such that the support structure 12 is properly and securely positioned in a vertical direction against the vehicle structure 34 such as a vehicle frame (not shown) and/or outer sheet metal (shown as vehicle structure 34). Also shown in FIG. 3 is a chrome plated metal cover 24 which may be disposed over the support structure 12. The chrome-plated metal cover 24 may be affixed to the support structure 12 using mechanical fasteners, adhesives or a bonding process.

In contrast to the traditional chrome plated bumpers, the chrome plated metal cover 24 of the present disclosure may have a gauge which is reduced from a range of 1.4-1.8 mm thick to less than 1 mm thick. The range may therefore be approximately 0.9 mm to 1.2 mm thick thereby reducing the weight of the bumper assembly 10.

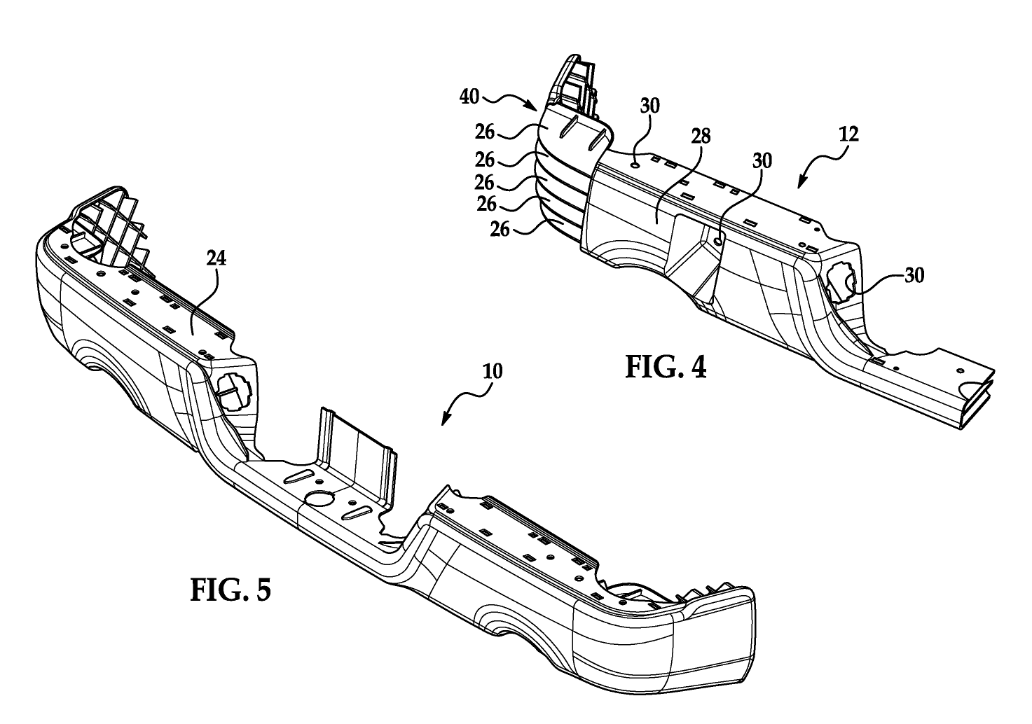

Referring now to FIG. 4 of the present disclosure, a partial rear isometric view of a non-limiting example of the support structure 12 of the present disclosure is shown. FIG. 4 illustrates an outer surface 28 of the substantially vertical walls 20 of the support structure 12. In the corner portion 40 of the support structure 12, horizontal ribs 26 may be integrally formed on the outer surface 28 of the support structure 12. The ends of the horizontal ribs 26 may abut the interior surface 18 of the chrome plated metal cover 24. Given that the support structure 12 is a polymeric component, any issues about galvanic corrosion in the abutment between the support structure 12 and the chrome-plated metal cover 24 are resolved. Similar to the diagonal ribs 16 formed on the interior surface 18 of the support structure 12, the horizontal ribs 26 are integral to the substantially vertical walls 20 and improve strength and stiffness in the support structure 12 while also reducing weight.

As shown, apertures 30 may also be created or defined in the support structure 12 to accommodate components such as lighting modules (not shown) and/or wiring harnesses (not shown).

With reference to FIG. 5, an embodiment of the bumper assembly 10 is shown in a rear isometric view wherein the chrome plated metal cover 24 is disposed on the support structure 12. As shown, the support structure 12 is configured to have an outer surface 28 which continuously and substantially abuts the inner surface of the chrome plated metal cover 24. Furthermore, the chrome plated metal cover 24 having a reduced thickness in the approximate range of 0.6 mm to 0.9 mm obscures the support structure 12 from view once installed on a vehicle.

Accordingly, the single piece, polymeric support structure 12 in conjunction with the chrome-plated metal cover 24 having a reduced thickness provides a bumper assembly 10 with increased strength and reduced weight.

It will be appreciated by those skilled in the art that, although the invention has been described with reference to one or more preferred embodiments, the invention is not limited to these disclosed embodiments and that various alternative embodiments or modifications to the disclosed embodiments could be made without departing from the scope of the invention.

What is claimed is:

1. A vehicle bumper assembly comprising:
a one-piece polymeric support structure having a plurality of ribs formed on a substantially vertical wall; and
a chrome-plated metal cover disposed on the one-piece polymeric support structure.

2. The vehicle bumper assembly as defined in claim 1 wherein the plurality of ribs intersect each other.

3. The vehicle bumper assembly as defined in claim 2 wherein the plurality of ribs intersect each other to form a honeycomb structure.

4. The vehicle bumper assembly as defined in claim 1 further comprising horizontal ribs defined on the outside corners of the support structure.

5. The vehicle bumper assembly as defined in claim 1 wherein the plurality of ribs are formed on an interior surface of the support structure.

6. The vehicle bumper assembly as defined in claim 2 wherein the plurality of ribs are disposed in opposing, diagonal directions.

7. The vehicle bumper assembly as defined in claim 1 wherein the chrome-plated metal cover has a thickness in the range of about 0.9 mm to 1.2 mm.

8. The vehicle bumper assembly as defined in claim 1 wherein the chrome-plated metal cover is affixed to the support structure using mechanical fasteners.

9. The vehicle bumper assembly as defined in claim 1 wherein the chrome-plated metal cover is affixed to the support structure using an adhesive.

10. The vehicle bumper assembly as defined in claim 1 wherein the chrome-plated metal cover is affixed to the support structure using a bonding process.

11. A vehicle bumper assembly comprising:
a multi-piece polymeric support structure having a plurality of ribs formed on a substantially vertical wall; and
a chrome-plated metal cover disposed on the one-piece polymeric support structure.

12. The vehicle bumper assembly as defined in claim 11 wherein the plurality of ribs intersect each other.

13. The vehicle bumper assembly as defined in claim 12 wherein the plurality of ribs intersect each other to form a honeycomb structure.

14. The vehicle bumper assembly as defined in claim 11 further comprising horizontal ribs defined on the outside corners of the support structure.

15. The vehicle bumper assembly as defined in claim 11 wherein the plurality of ribs are formed on an interior surface of the support structure.

16. The vehicle bumper assembly as defined in claim 12 wherein the plurality of ribs are disposed in opposing, diagonal directions.

17. The vehicle bumper assembly as defined in claim 11 wherein the chrome-plated metal cover has a thickness in the range of about 0.9 mm to 1.2 mm.

18. The vehicle bumper assembly as defined in claim 11 wherein the chrome-plated metal cover is affixed to the support structure using mechanical fasteners.

19. The vehicle bumper assembly as defined in claim 11 wherein the chrome-plated metal cover is affixed to the support structure using an adhesive.

20. The vehicle bumper assembly as defined in claim 11 wherein the chrome-plated metal cover is affixed to the support structure using a bonding process.
